(19) United States
(12) Patent Application Publication
(10) Pub. No.: US 2012/0043913 A1
(43) Pub. Date: Feb. 23, 2012

(54) Dimmer Output Emulation

(76) Inventor: John L. Melanson, Austin, TX (US)

(21) Appl. No.: 12/858,164

(22) Filed: Aug. 17, 2010

(51) Int. Cl. H05B 37/02

(52) U.S. Cl. 315/307

(57) ABSTRACT

A lighting system includes a dimmer output voltage emulator to cause a power converter interface circuit to generate an emulated dimmer output voltage. In at least one embodiment, the emulated dimmer output voltage corresponds to an actual dimmer output voltage but is unaffected by non-idealities in the dimmer output voltage, such as premature shut-down of a triac-based dimmer. By generating an emulated dimmer output voltage, the energy delivered to a load, such as a lamp, corresponds to a dimming level setting.

### BACKGROUND OF THE INVENTION

1. Field of the Invention

The present invention relates in general to the field of electronics, and more specifically to method and system for dimmer output emulation.

2. Description of the Related Art

Electronic systems utilize dimmers to direct modification of output power to a load. For example, in a lighting system, dimmers provide an input signal to a lighting system. The input signal represents a dimming level that causes the lighting system to adjust power delivered to a lamp, and, thus, depending on the dimming level, increase or decrease the brightness of the lamp. Many different types of dimmers exist. In general, dimmers use a digital or analog coded dimming signal that indicates a desired dimming level. For example, some analog based dimmers utilize a triode for alternating current (“triac”) device to modulate a phase angle of each cycle of an alternating current (“AC”) supply voltage. “Modulating the phase angle” of the supply voltage is also commonly referred to as “chopping” the supply voltage. Chopping the supply voltage causes the voltage supplied to a lighting system to rapidly turn “ON” and “OFF” thereby controlling the energy provided to a lighting system.

FIG. 1 depicts a lighting system 100 that includes a triac-based dimmer 102. FIG. 2 depicts exemplary voltage graphs 200 associated with the lighting system 100. Referring to FIGS. 1 and 2, the lighting system 100 receives an AC supply voltage V_{SUPPLY} from voltage supply 104. The supply voltage V_{SUPPLY} is, for example, a nominally 60 Hz/110 V line voltage in the United States of America or a nominally 50 Hz/220 V line voltage in Europe. Triac 106 acts as voltage-driven switch, and a gate terminal 108 of triac 106 controls current flow between the first terminal 110 and the second terminal 112. A gate voltage V_{G} on the gate terminal 108 will cause the triac 106 to turn ON and current i_{DIM} when the gate voltage V_{G} reaches a firing threshold voltage value V_{F} and a voltage potential exists across the first and second terminals 110 and 112. The dimmer output voltage V_{φ}_{_{—}}_{DIM} is zero volts from the beginning of each of half cycles 202 and 204 at respective times t₀ and t₂ until the gate voltage V_{G} reaches the firing threshold voltage value V_{F}. Dimmer output voltage V_{φ}_{_{—}}_{DIM} represents the output voltage of dimmer 102. During timer period T_{OFF}, the dimmer 102 chops the supply voltage V_{SUPPLY} so that the dimmer output voltage V_{φ}_{_{—}}_{DIM} remains at zero volts during time period T_{OFF.} At time t₁, the gate voltage V_{G} reaches the firing threshold value V_{F}, and triac 106 begins conducting. Once triac 106 turns ON, the dimmer voltage V_{φ}_{_{—}}_{DIM} tracks the supply voltage V_{SUPPLY} during time period T_{ON}. Once triac 106 turns ON, triac 106 continues to conduct current i_{DIM} regardless of the value of the gate voltage V_{G} as long as the current i_{DIM} remains above a holding current value HC. The holding current value HC is a function of the physical characteristics of the triac 106. Once the current i_{DIM} drops below the holding current value HC, i.e. i_{DIM}<HC, triac 106 turns OFF, i.e. stops conducting, until the gate voltage V_{G} again reaches the firing threshold value V_{F}. The holding current value HC is generally low enough so that, ideally, the current i_{DIM} drops below the holding current value HC when the supply voltage V_{SUPPLY} is approximately zero volts near the end of the half cycle 202 at time t₂.

The variable resistor 114 in series with the parallel connected resistor 116 and capacitor 118 form a timing circuit 115 to control the time t₁ at which the gate voltage V_{G} reaches the firing threshold value V_{F}. Increasing the resistance of variable resistor 114 increases the time T_{OFF}, and decreasing the resistance of variable resistor 114 decreases the time T_{OFF}. The resistance value of the variable resistor 114 effectively sets a dimming value for lamp 122. Diac 119 provides current flow into the gate terminal 108 of triac 106. The dimmer 102 also includes an inductor choke 120 to smooth the dimmer output voltage V_{φ}_{_{—}}_{DIM}. Triac-based dimmer 102 also includes a capacitor 121 connected across triac 106 and inductor 120 to reduce electro-magnetic interference.

Ideally, modulating the phase angle of the dimmer output voltage V_{φ}_{_{—}}_{DIM} effectively turns the lamp 122 OFF during time period T_{OFF} and ON during time period T_{ON} for each half cycle of the supply voltage V_{SUPPLY}. Thus, ideally, the dimmer 102 effectively controls the average energy supplied to the lamp 122 in accordance with the dimmer output voltage V_{φ}_{_{—}}_{DIM}.

The triac-based dimmer 102 adequately functions in many circumstances. However, when the lamp 122 draws a small amount of current i_{DIM}, the current i_{DIM} can prematurely drop below the holding current value HC before the supply voltage V_{SUPPLY} reaches approximately zero volts. When the current i_{DIM} prematurely drops below the holding current value HC, the dimmer 102 prematurely shuts down, and the dimmer voltage V_{φ}_{_{—}}_{DIM} will prematurely drop to zero. When the dimmer voltage V_{φ}_{_{—}}_{DIM} prematurely drops to zero, the dimmer voltage V_{φ}_{_{—}}_{DIM} does not reflect the intended dimming value as set by the resistance value of variable resistor 114. For example, when the current i_{DIM} drops below the holding current value HC at time t₃ for the dimmer voltage V_{φ}_{_{—}}_{DIM} 206, the ON time period T_{ON} prematurely ends at time earlier than t₂, such as time t₃, instead of ending at time t₂, thereby decreasing the amount of energy delivered to lamp 122. Thus, the energy delivered to lamp 122 will not match the dimming level corresponding to the dimmer voltage V_{φ}_{_{—}}_{DIM}.

### SUMMARY OF THE INVENTION

In one embodiment of the present invention, an apparatus includes a dimmer output voltage emulator configured to cause a power converter interface circuit to generate an emulated dimmer output voltage. The emulated dimmer output voltage emulates part of a cycle of an alternating current dimmer output voltage of a dimmer.

In another embodiment of the present invention, a method includes causing a power converter interface circuit to generate an emulated dimmer output voltage. The emulated dimmer output voltage emulates part of a cycle of an alternating current dimmer output voltage of a dimmer.

In a further embodiment of the present invention, an apparatus includes a dimmer and a power converter interface circuit coupled to the dimmer The apparatus further includes a dimmer output voltage emulator, coupled to the power converter interface circuit. The dimmer output voltage emulator is configured to cause a power converter interface circuit to generate an emulated dimmer output voltage. The emulated dimmer output voltage emulates part of a cycle of an alternating current dimmer output voltage of a dimmer The apparatus further includes a power converter coupled to the dimmer output voltage emulator and a controller coupled to the dimmer output voltage emulator and the power converter. The controller is configured to control the power converter in accordance with the emulated dimmer output voltage.

In another embodiment of the present invention, an apparatus includes means for causing a power converter interface circuit to generate an emulated dimmer output voltage. The emulated dimmer output voltage emulates part of a cycle of an alternating current dimmer output voltage of a dimmer.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 (labeled prior art) depicts a lighting system that includes a triac-based dimmer.

FIG. 2 (labeled prior art) depicts exemplary voltage graphs associated with the lighting system of FIG. 1.

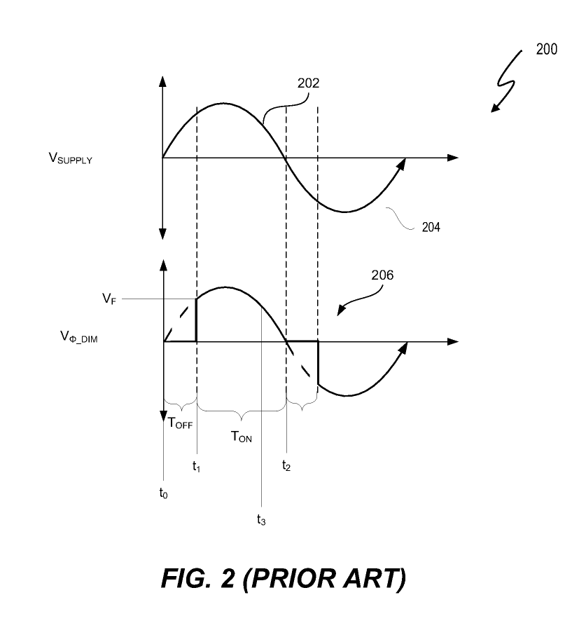

FIG. 3 depicts a lighting system having a dimmer output voltage emulator.

FIG. 4 depicts an embodiment of the lighting system of FIG. 3.

FIG. 5 depicts exemplary voltage graphs associated with the lighting system of FIG. 4.

FIG. 6 depicts a dimmer emulator embodiment of the lighting system of FIG. 4.

FIG. 7 depicts current-voltage and voltage-time graphs involving the dimmer emulator of FIG. 6.

FIG. 8 depicts a dimmer emulator embodiment of the lighting system of FIG. 4.

FIG. 9 depicts current-voltage and voltage-time graphs involving the dimmer emulator of FIG. 8.

FIG. 10 depicts a dimmer emulator embodiment of the lighting system of FIG. 4.

FIG. 11 depicts current-voltage and voltage-time graphs involving the dimmer emulator of FIG. 10.

FIG. 12 depicts an embodiment of the lighting system of FIG. 3 with additional link voltage capacitors.

### DETAILED DESCRIPTION

In at least one embodiment, a lighting system includes a dimmer output voltage emulator to cause a power converter interface circuit to generate an emulated dimmer output voltage. In at least one embodiment, the emulated dimmer output voltage corresponds to an actual dimmer output voltage but is unaffected by non-idealities in the dimmer output voltage, such as premature shut-down of a triac-based dimmer. By generating an emulated dimmer output voltage, the energy delivered to a load, such as a lamp, corresponds to a dimming level setting.

In at least one embodiment, the power converter interface circuit interfaces with a triac-based dimmer circuit. In at least one embodiment, the dimmer output voltage emulator causes the power converter interface circuit to emulate the output voltage of the triac-based dimmer circuit after the triac in the triac-based dimmer begins conducting. In at least one embodiment, the lighting system draws too little current to allow the triac to conduct until a supply voltage reaches approximately zero. In at least one embodiment, the dimmer output voltage emulator effectively isolates the power converter interface circuit from the triac-based dimmer, and the emulated dimmer output voltage allows the lighting system to function in a normal mode that is equivalent to when the triac ideally continues to conduct until the supply voltage reaches approximately zero. In at least one embodiment, the dimmer output voltage emulator also causes the power converter interface circuit to appear as a low impedance to the triac-based dimmer circuit to allow timing circuitry in the dimmer circuit to reset and begin an operation for the next cycle of the supply voltage.

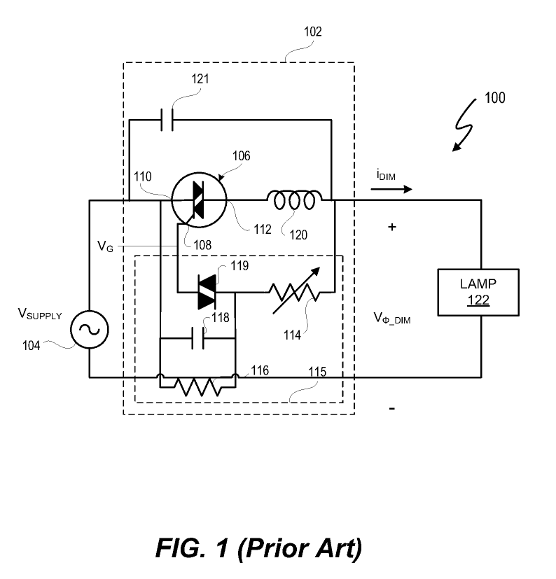

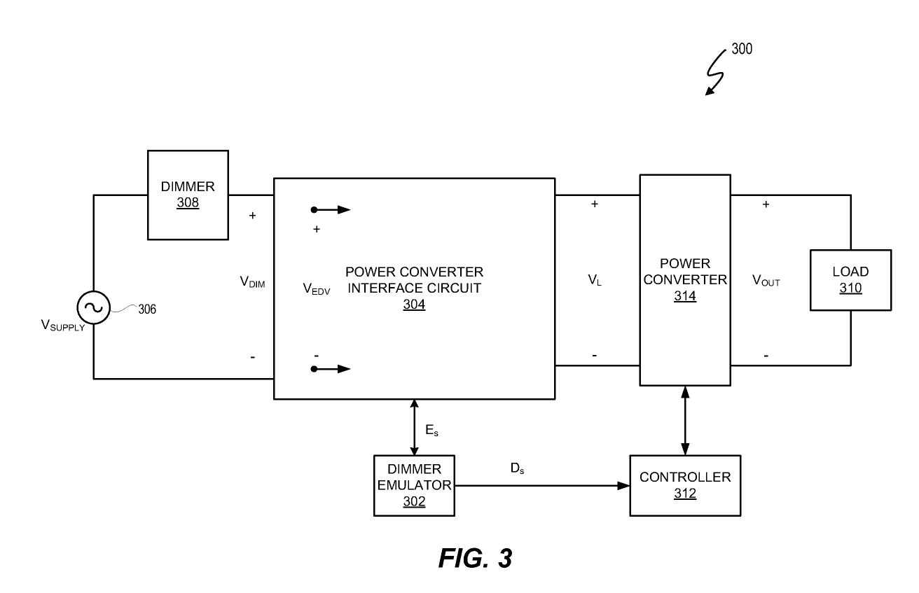

FIG. 3 depicts a lighting system 300 having a dimmer output voltage emulator 302 that is configured to cause a power converter interface circuit 304 to generate an emulated dimmer output voltage V_{EDV}. The voltage supply 306 generates a supply voltage V_{SUPPLY}, which in one embodiment is identical to the supply voltage generated by voltage supply 104 (FIG. 1). The dimmer 308 generates a dimmer voltage V_{DIM} and provides the dimmer voltage V_{DIM} to the power converter interface circuit 304. In at least one embodiment, the dimmer 308 is identical to triac-based dimmer 102 (FIG. 1). In at least one embodiment, the dimmer emulator 302 senses the dimmer voltage V_{DIM} and generates an emulator signal E_{S} that causes the power converter interface circuit 304 to generate an emulated dimmer output voltage V_{EDV}. The emulated dimmer output voltage V_{EDV} functions as a dimmer output voltage. The power converter interface circuit 304 converts the emulated dimmer output voltage V_{EDV} into a link voltage V_{L} to power converter 314.

The dimmer emulator 302 also provides a dimmer information signal D_{S} to controller 312. The dimmer information signal D_{S} indicates how much energy power converter 314 should provide to load 310. For example, if dimmer signal V_{DIM} indicates a 50% dimming level, then the dimmer information signal D_{S} indicates a 50% dimming level. Controller 312 responds to the dimmer information signal D_{S} and causes power converter 314 to provide 50% power to load 310. The particular generation of emulator signal E_{S} and dimmer information signal D_{S} are matters of design choice and, for example, depend on the particular respective designs of power converter interface circuit 304 and controller 312. In at least one embodiment, dimmer emulator 302 includes an analog-to-digital converter to convert the dimmer signal V_{DIM} into a digital dimmer information signal D_{S}. In at least one embodiment, dimmer emulator 302 includes a timer that determines the phase delay of the dimmer signal V_{DIM} and converts the phase delay into dimmer information signal D_{S}. In at least one embodiment, the emulator signal E_{S} is a current that controls the emulated dimmer output voltage V_{EDV}. In at least one embodiment, emulator signal E_{S} and dimmer signal information signal D_{S} are two different signals. In at least one embodiment, emulator signal Es and dimmer information signal D_{S} are the same signal. Load 310 can be any type of load. In at least one embodiment, load 310 includes one or more lamps, such as one or more light emitting diodes (LEDs). The particular type and design of controller 312 is a matter of design choice. An exemplary controller 312 is available from Cirrus Logic, Inc. having offices in Austin, Tex., USA. The particular type and design of power converter 314 is a matter of design choice. In at least one embodiment, power converter 314 is a switching power converter, such as a boost-type, buck-type, boost-buck-type, or Cúk-type switching power converter. In at least one embodiment, power converter 314 provides power factor correction and regulates the output voltage V_{OUT} and/or current delivered to load 310. U.S. Pat. No. 7,719,246, entitled “Power Control System Using a Nonlinear Delta-Sigma Modulator with Nonlinear Power Conversion Process Modeling”, filed Dec. 31, 2007, inventor John L. Melanson describes exemplary power converters and controllers.

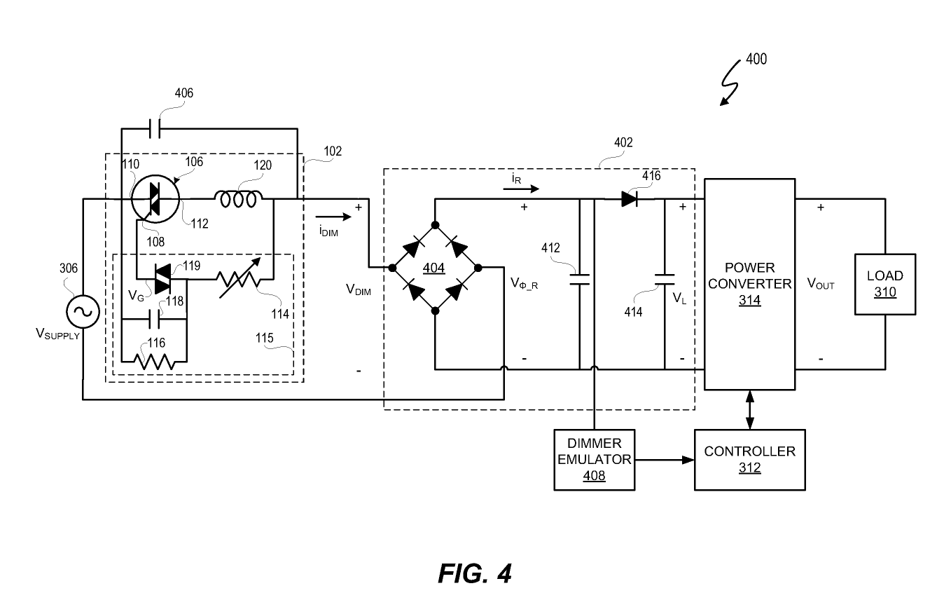

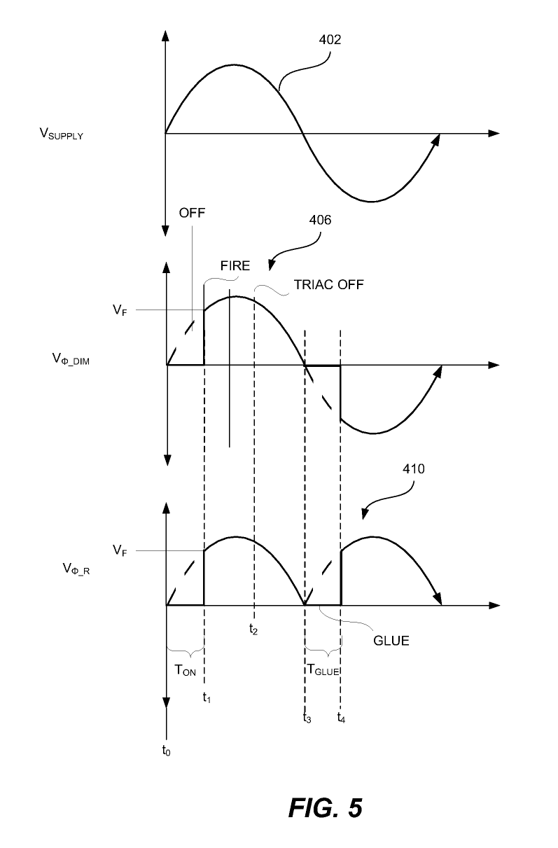

FIG. 4 depicts lighting system 400, which represents one embodiment of lighting system 300. FIG. 5 depicts exemplary voltage graphs 500 associated with the lighting system 400. Voltage supply 306 provides supply voltage V_{SUPPLY}, and triac-based dimmer 102 generates a dimmer voltage V_{φ}_{_{—}}_{DIM} as described in conjunction with FIG. 1. In the embodiment of FIG. 5, the triac 106 turns ON at time t₁ when the supply voltage V_{SUPPLY} is at 45° and 225°. The power converter interface circuit 402, which represents one embodiment of power converter interface 304, includes a full-bridge diode rectifier 404 that rectifies the dimmer voltage V_{φ}_{_{—}}_{DIM} to generate voltage V_{φ}_{_{—}}_{R}, while the triac 106 is ON between times t₁ and t₂. The voltage V_{φ}_{_{—}}_{R} recharges capacitor 414. In at least one embodiment, the load 310 presents a low wattage load to power interface circuit 402. For example, in at least one embodiment, load 310 includes one or more low wattage lamps, such as 5-10 W light emitting diodes (“LEDs”). In this embodiment, load 310 draws a relatively small amount of current which causes the dimmer current i_{DIM} to drop below the holding current value HC at time t₂. Thus, in the embodiment of FIG. 5, the current i_{DIM} falls below the holding current value HC, and triac 106 turns OFF prematurely at time t₂. Conventionally, when triac 106 turns OFF at time t₂, triac 106 would chop the trailing edge of rectified voltage V_{φ}_{_{—}}_{R} at time t₂. However, the dimmer emulator 408, which represents one embodiment of dimmer emulator 302, causes the power converter interface circuit 402 to emulate a continuous rectified voltage V_{φ}_{_{—}}_{R}.

When the triac 106 turns OFF, capacitor 406 maintains the voltage across triac 106 and inductor 120 low so that very little current is drawn from the timing circuit 115 during time period T_{ON}. In at least one embodiment, the current drawn from the timing circuit 115 is low enough to prevent the triac 106 from firing prior to the next phase cut ending time at time t₄. Capacitor 406 has a capacitance value of, for example, 100 nF.

In at least one embodiment, the supply voltage V_{SUPPLY} is a sine wave. Thus, the ideal voltage V_{φ}_{_{—}}_{R} during the ON period T_{ON} is a portion of a sine wave. The voltage V_{φ}_{_{—}}_{R} charges capacitor 412. A current i_{R} that is proportional to the derivative of the voltage V_{φ}_{_{—}}_{R} over time, i.e. i_{R} α dV_{φ}_{_{—}}_{R}/dt, and drawn from capacitor 412 will cause the voltage V_{φ}_{_{—}}_{R} across capacitor 412 to emulate the dimmer output voltage V_{DIM} that would occur if the dimmer current i_{DIM} remained above the holding current value HC. Thus, when triac 106 turns OFF, the voltage V_{φ}_{_{—}}_{R} becomes an emulated dimmer output voltage (emulated dimmer output voltage V_{EDV} of FIG. 3). Accordingly, in at least one embodiment, the dimmer emulator 408 generates a current i_{R} to cause power converter interface circuit 402 to generate voltage V_{φ}_{_{—}}_{R} as the emulated dimmer output voltage V_{EDV} . When the dimmer emulator 408 generates a current i_{R} to cause power converter interface circuit 402 to generate voltage V_{φ}_{_{—}}_{R}, voltage V_{φ}_{_{—}}_{R} is referred to as the “emulated dimmer output voltage V_{φ}_{_{—}}_{R}”.

When the triac 106 is turned ON, current i_{R} charges link capacitor 414 through diode 416 as long as the voltage V_{φ}_{_{—}}_{R} exceeds the link voltage V_{L} by at least the forward-biased voltage (e.g. 0.7V) of diode 416. In at least one embodiment, link capacitor 414 has a large enough capacitance to provide an approximately constant link voltage V_{LINK} to power converter 314. In at least one embodiment, the capacitance of capacitor 412 is 10 nF, and the capacitance of link capacitor 414 is 1.5 μF.

As the voltage V_{φ}_{_{—}}_{R} decreases, the current i_{DIM} decreases below the holding current value HC at time t₂, and the triac 106 turns OFF at time t₂. The dimmer emulator 408 then discharges capacitor 412 by drawing current i_{R} from capacitor 412. During the time between t₂ and t₃, the dimmer emulator 408 draws current i_{R} in proportion to dV_{φ}_{_{—}}_{R}/dt so that, in at least one embodiment, the emulated dimmer output voltage V_{φ}_{_{—}}_{R} emulates a decreasing sine wave. As the voltage V_{φ}_{_{—}}_{R} approaches zero volts at time t₃, the dimmer emulator 408 draws sufficient current i_{R} from capacitor 412 to hold the voltage V_{φ}_{_{—}}_{R} low, i.e. approximately 0 volts, until the triac 106 turns ON again at time t₄. Holding the voltage V_{φ}_{_{—}}_{R} low during the OFF period T_{OFF} allows the timing circuitry 115 to reset and turn triac 106 ON at time t₄ during the next half cycle of the supply voltage V_{SUPPLY}.

The particular design of dimmer emulator 408 and the particular waveform of the emulated dimmer output voltage V_{φ}_{_{—}}_{R} are matters of design choice. In at least one embodiment, the particular waveform of emulated dimmer output voltage V_{φ}_{_{—}}_{R} is determined by the current i_{R}. In at least one embodiment, if the dimmer emulator 408 draws too much current i_{R}, capacitor 406 will discharge prior to a zero crossing at time t₃ of the supply voltage V_{SUPPLY} and cause the firing of triac 106 to be out of sync with the zero crossing of supply voltage V_{SUPPLY}. If the firing of triac 106 is out of sync with the zero crossing of supply voltage V_{SUPPLY}, the phase cut of supply voltage V_{SUPPLY} will occur at the wrong angle. In addition to erroneously modifying the phase cut timing of the supply voltage V_{SUPPLY}, drawing too much current from capacitor 406 can cause at least a second firing of triac 106 during a cycle of V_{φ}_{_{—}}_{R}. Multiple firings of triac 106 during a single cycle can cause flicker in a lamp of load 310 or cause instability in the triac-based dimmer 102. Because the bridge rectifier 404 prevents current from flowing from the power converter interface circuit 402 into triac-based dimmer 102, drawing too little current i_{R} can cause the emulated dimmer output voltage V_{φ}_{_{—}}_{R} to decrease too slowly to reach approximately 0V at time t₃. If the emulated dimmer output voltage V_{φ}_{_{—}}_{R} does not reach approximately 0V at time t₃, dimmer emulator 408 may not properly hold the emulated dimmer output voltage V_{φ}_{_{—}}_{R} at approximately 0V, which can also cause instability and flickering in a lamp of load 310.

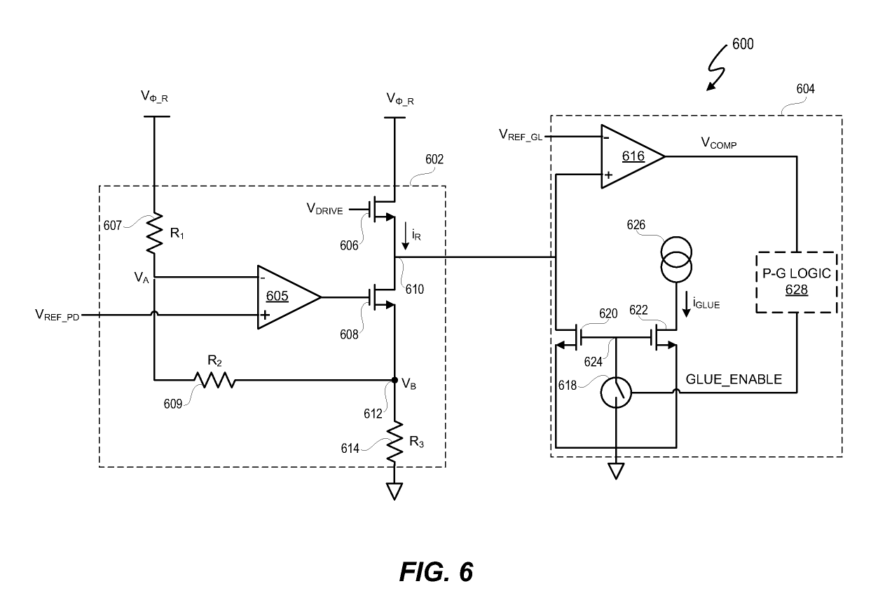

FIG. 6 depicts a dimmer emulator 600, which represents one embodiment of dimmer emulator 408. Dimmer emulator 600 represents one embodiment of a current source that controls the current i_{R}. Dimmer emulator 600 includes a pull-down circuit 602 to pull-down current i_{R} after the triac 106 (FIG. 4) turns OFF, and a hold or “glue” circuit 604 to hold the emulated dimmer output voltage V_{φ}_{_{—}}_{R} to approximately 0V until the triac 106 fires in a next half-cycle of dimmer voltage V_{DIM}.

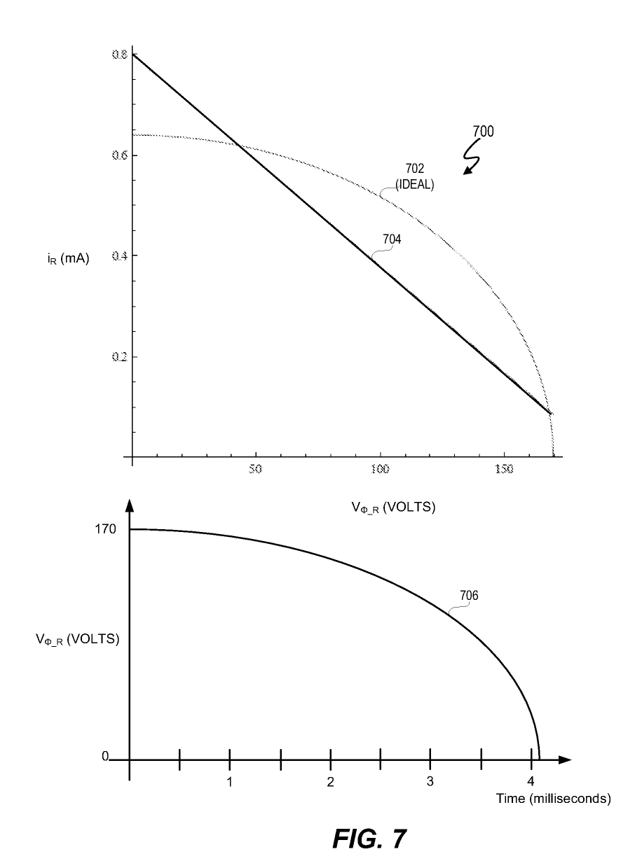

FIG. 7 depicts current-voltage graphs 700 involving the emulated dimmer output voltage V_{φ}_{_{—}}_{R}, which is caused by an embodiment of pull-down circuit 602. Referring to FIGS. 6 and 7, since the supply voltage V_{SUPPLY} is a cosine wave, and the current i_{R} is directly related to the derivative of the emulated dimmer output voltage V_{φ}_{_{—}}_{R}, the ideal relationship between the current i_{R} and the emulated dimmer output voltage V_{φ}_{_{—}}_{R} for a half cycle of supply voltage V_{SUPPLY} is a quarter sine wave 702. However, a linearly decreasing relationship 704 between current i_{R} and emulated dimmer output voltage V_{φ}_{_{—}}_{R} is a close approximation of the ideal waveform 702. The i_{R} versus emulated dimmer output voltage V_{φ}_{_{—}}_{R} relationship 704 causes the power converter interface circuit 402 to generate an oval emulated dimmer output voltage V_{φ}_{_{—}}_{R} versus time graph 706, which is a close approximation to a phase cut supply voltage V_{SUPPLY}.

In general, the pull-down circuit 602 creates the linearly decreasing relationship 704 between current i_{R} and emulated dimmer output voltage V_{φ}_{_{—}}_{R}. The pull-down circuit 602 includes an operational amplifier 605 which includes a non-inverting input terminal “+” to receive a pull-down reference voltage V_{REF}_{_{—}}_{PD}. A feedback loop with voltage divider R1 and R2 between the emulated dimmer output voltage V_{φ}_{_{—}}_{R} terminal 605 and voltage V_{B} at node 612 creates an inverse relationship between voltage V_{B} and emulated dimmer output voltage V_{φ}_{_{—}}_{R}. Thus, as the emulated dimmer output voltage V_{φ}_{_{—}}_{R} decreases, operational amplifier 605 drives the gate of n-channel metal oxide semiconductor field effect transistor (NMOSFET) 608 to increase the voltage V_{B} so that the voltage V_{A} at the inverting terminal “−” matches the reference voltage V_{REF}_{_{—}}_{PD} at the non-inverting terminal “+”. Similarly, as the emulated dimmer output voltage V_{φ}_{_{—}}_{R} increases, operational amplifier 605 drives the gate of n-channel metal oxide semiconductor field effect transistor (NMOSFET) 608 to decrease the voltage V_{B} so that the voltage V_{A} at the inverting terminal “−” continues to match the reference voltage V_{REF}_{_{—}}_{PD} at the non-inverting terminal “+”.

The voltage V_{DRIVE} at the gate of NMOSFET 606 maintains NMOSFET in saturation mode. In at least one embodiment, voltage V_{DRIVE} is +12V. The voltage V_{B} across resistor 614 determines the value of current i_{R}, i.e. i_{R}=V_{B}/R3, and “R3” is the resistance value of resistor 614. Thus, current i_{R} varies directly with voltage V_{B} and, thus, varies inversely with emulated dimmer output voltage V_{φ}_{_{—}}_{R} as depicted by the linearly decreasing i_{R} versus V_{φ}_{_{—}}_{R} relationship 704. From the topology of pull-down circuit 602, voltage V_{B} is related to the reference voltage V_{REF}_{_{—}}_{PD} in accordance with Equation [1]:

$${V}_{B} = {V}_{REF \_ PD} \cdot \frac{R 1 + R 2}{R 1} - \frac{R 2 \cdot {V}_{Φ\_ R}}{R 1} \qquad [ 1 ]$$

R1 is the resistance value of resistor 607, and R2 is the resistance value of resistor 609. If R1>>R2, then the voltage V_{B} is represented by Equation [1] [2]

$${V}_{B} \approx {V}_{REF \_ PD} - \frac{R 2 \cdot {V}_{Φ\_ R}}{R 1} \qquad [ 2 ]$$

Since i_{R}=V_{B}/R3, if R1 is 10 Mohms, R2 is 42 kohms, and R3 is 1 kohm, in accordance with Equation [2], i_{R} is represented by Equation [3]:

$${i}_{R} \approx 0.8 ( 1 - \frac{{V}_{Φ\_ R}}{190} ) mA \qquad [ 3 ]$$

Once the pull-down circuit 602 lowers the emulated dimmer output voltage V_{φ}_{_{—}}_{R} to a glue down reference voltage V_{REF}_{_{—}}_{GL}, the glue-down circuit 604 holds the emulated dimmer output voltage V_{φ}_{_{—}}_{R} at or below a threshold voltage, such as approximately 0V, until the triac 106 fires and raises the emulated dimmer output voltage V_{φ}_{_{—}}_{R}. Comparator 616 of glue-down circuit 604 compares the emulated dimmer output voltage V_{φ}_{_{—}}_{R} with the glue-down reference voltage V_{REF}_{_{—}}_{GL}. The particular value of the glue-down reference voltage V_{REF}_{_{—}}_{GL} is a matter of design choice. In at least one embodiment, voltage V_{REF}_{_{—}}_{GL} is set so that the glue-down circuit 604 holds the voltage V_{φ}_{_{—}}_{R} to approximately 0V when the voltage V_{φ}_{_{—}}_{R} approaches 0V. In at least one embodiment, the glue-down reference voltage V_{REF}_{_{—}}_{GL} is set to 5V. Since NMOSFET 606 operates in saturation mode, the voltage at node 610 is approximately equal to emulated dimmer output voltage V_{φ}_{_{—}}_{R}. When emulated dimmer output voltage V_{φ}_{_{—}}_{R} is greater than the glue-down reference voltage V_{REF}_{_{—}}_{GL}, the output voltage V_{COMP} of comparator 616 is a logical 0. In at least one embodiment, the comparator output voltage V_{COMP} is passed directly as signal GLUE_ENABLE to a control terminal of switch 618. Switch 618 can be any type of switch and is, for example, an NMOSFET. When the comparator output voltage V_{COMP} is a logical 0, switch 618 is OFF, and NMOSFETs 620 and 622 are also OFF. When emulated dimmer output voltage V_{φ}_{_{—}}_{R} transitions from greater than to less than the glue-down reference voltage V_{REF}_{_{—}}_{GL}, the comparator output voltage V_{COMP} changes from a logical 0 to a logical 1. When the comparator output voltage V_{COMP} is a logical 1, NMOSFETs 620 and 622 conduct. NMOSFETs 620 and 622 are configured as a current mirror sharing a common gate terminal 624. A current source 626 generates a glue current i_{GLUE,} which is mirrored through NMOSFET 620. In at least one embodiment, when emulated dimmer output voltage V_{φ}_{_{—}}_{R} is less than glue-down reference voltage V_{REF}_{_{—}}_{GL}, current i_{R} is approximately equal to the glue current i_{GLUE}. In at least one embodiment, the glue current i_{GLUE} is set to a value large enough to hold the emulated dimmer output voltage V_{φ}_{_{—}}_{R} at approximately 0V until the triac 106 (FIG. 4) fires again. In at least one embodiment, the glue current i_{GLUE} is at least as large as the holding current value HC of dimmer 102 (FIG. 4), such as 250 mA. Thus, the glue circuit 604 draws a steady state glue current i_{GLUE} from the power converter interface circuit 402 to maintain the emulated dimmer output voltage V_{φ}_{_{—}}_{R} at or below a threshold voltage, such as approximately 0V, during a period of time from when the pull-down circuit 602 lowers the emulated dimmer output voltage V_{φ}_{_{—}}_{R} to the glue down reference voltage V_{REF}_{_{—}}_{GL} until the triac 106 fires and raises the emulated dimmer output voltage V_{φ}_{_{—}}_{R}.

In at least one embodiment, the glue circuit 604 also includes pull-down, glue logic (“P-G logic”) 628. The P-G logic 628 generates the signal GLUE_ENABLE to control conductivity of switch 618. The particular function(s) of P-G logic 628 are a matter of design choice. For example, in at least one embodiment, P-G logic 628 enables and disables the glue-down circuit 604. In at least one embodiment, to enable and disable the glue-down circuit 604, P-G logic 628 determines whether the dimmer output voltage V_{φ}_{_{—}}_{DIM} contains any phase cuts. If the dimmer output voltage V_{φ}_{_{—}}_{DIM} does not indicate any phase cuts, then the P-G logic 628 disables the glue down circuit 604 by generating the GLUE_ENABLE signal so that switch 618 does not conduct regardless of the value of comparator output voltage V_{COMP}. In at least one embodiment, P-G logic 628 includes a timer (not shown) that determines how often the comparator output voltage V_{COMP} changes logical state. If the time between logical state changes is consistent with no phase cuts, P-G logic 628 disables the glue-down circuit 604.

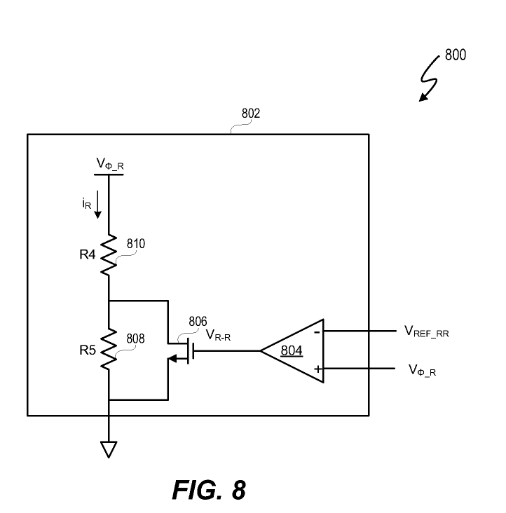

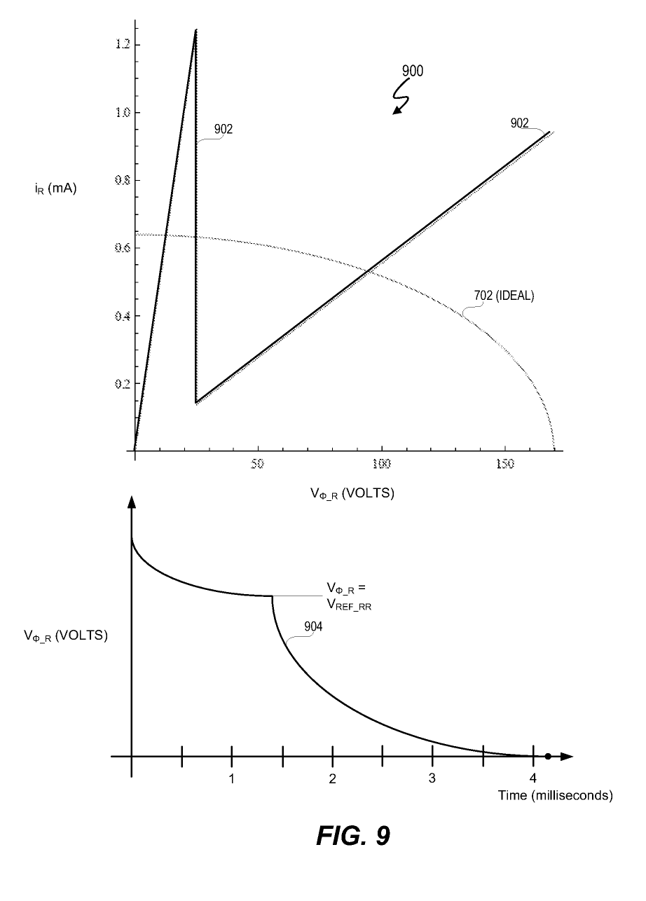

Referring to FIG. 4, the dimmer emulator 408 can be implemented in any of a variety ways. For example, FIG. 8 depicts a dimmer emulator 800, which represents one embodiment of dimmer emulator 408. The dimmer emulator 800 includes a variable resistance circuit 802 that modifies the value of current i_{R} based on the value emulated dimmer output voltage V_{φ}_{_{—}}_{R}. FIG. 9 depicts current-voltage graphs 900 involving the emulated dimmer output voltage V_{φ}_{_{φ}}_{R}, which are caused by an embodiment of dimmer emulator 800. Referring to FIGS. 8 and 9, when emulated dimmer output voltage V_{φ}_{_{—}}_{R} is less than the reference voltage V_{REF}_{_{—}}_{RR}, the output voltage V_{R-R} of comparator 804 is a logical 0 and turns NMOSFET 806 OFF. When NMOSFET 806 is OFF, current i_{R} flows through both resistor 808 and serially connected resistor 810. When the comparator output voltage V_{R}_{_{—}}_{R} is a logical 1, NMOSFET 806 turns ON and operates in saturation mode, thereby allowing current i_{R} to bypass resistor 808.

The particular value of reference voltage V_{REF}_{_{—}}_{RR} and resistance values R4 and R5 of respective resistors 810 and 808 are matters of design choice. In the embodiment of current-voltage graphs 900, reference voltage V_{REF}_{_{—}}_{RR} is 25V, R4 is 20 kohms, and R5 is 180 kohms Thus, as depicted by the current i_{R} versus emulated dimmer output voltage V_{φ}_{_{—}}_{R} waveform 902, the current i_{R} increases rapidly relative to increases in voltage V_{φ}_{_{—}}_{R} in accordance with i_{R}=V_{φ}_{_{—}}_{R}/(R4+R5) with increases in emulated dimmer output voltage V_{φ}_{_{—}}_{R} when voltage V_{φ}_{_{—}}_{R} is less than reference voltage V_{REF}_{_{—}}_{RR}. When voltage V_{φ}_{_{—}}_{R} is greater than reference voltage V_{REF}_{_{—}}_{RR}, the current i_{R} increases less rapidly relative to increases in voltage V_{φ}_{_{—}}_{R}.

The emulated dimmer output voltage V_{φ}_{_{—}}_{R} versus time graph 904 depicts the emulated dimmer output voltage V_{φ}_{_{—}}_{R} decreasing over time in a concave parabolic waveform while voltage V_{φ}_{_{—}}_{R} is less than reference voltage V_{REF}_{_{—}}_{RR}, and decreasing more rapidly over time when voltage V_{φ}_{_{—}}_{R} is greater than reference voltage V_{REF}_{_{—}}_{RR}. Thus, the emulated dimmer output voltage V_{φ}_{_{—}}_{R} produced by dimmer emulator 408 causes the power converter interface 402 (FIG. 4) to emulate a dimmer output voltage, and the approximation of the emulated dimmer output voltage V_{φ}_{_{—}}_{R} 904 is not as close of an approximation to the ideal i_{R} versus emulated dimmer output voltage V_{φ}_{_{—}}_{R} 704 produced by the current source of dimmer emulator 408.

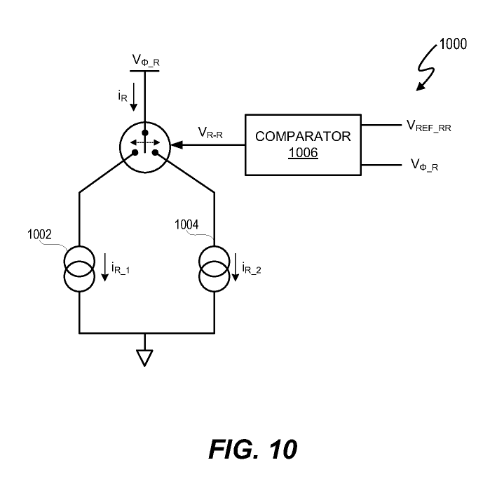

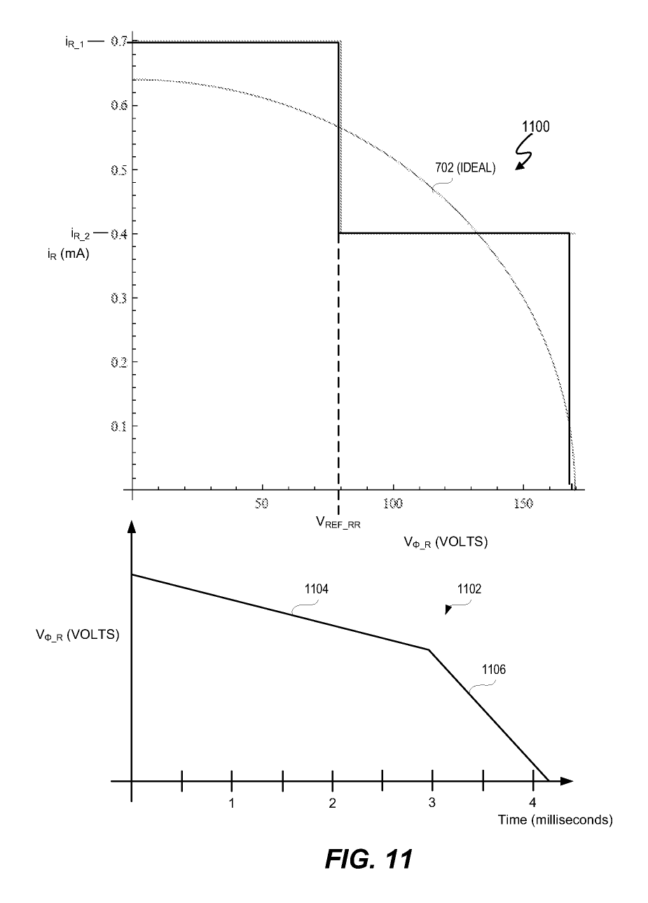

FIG. 10 depicts a dimmer emulator 1000, which represents another embodiment of dimmer emulator 408. Dimmer emulator 1000 is a switching, constant current source that switches between two constant current sources 1002 and 1004 to cause power converter interface 402 to generate an emulated dimmer output voltage V_{φ}_{_{—}}_{R}. FIG. 11 depicts current-voltage graphs 1100 involving the emulated dimmer output voltage V_{φ}_{_{—}}_{R}, which are caused by an embodiment of dimmer emulator 1000. Comparator 1006 compares the reference voltage V_{REF}_{_{—}}_{RR} to emulated dimmer output voltage V_{φ}_{_{—}}_{R}. The particular value of reference voltage V_{REF}_{_{—}}_{RR} is a matter of design choice and is preferably set to a value that allows the dimmer emulator 1000 to most accurately approximate the ideal i_{R} versus emulated dimmer output voltage V_{φ}_{_{—}}_{R} 702. In the embodiment of graphs 1100, the reference voltage V_{REF}_{_{—}}_{RR} is 80V. When the emulated dimmer output voltage V_{φ}_{_{—}}_{R} is less than the reference voltage V_{REF}_{_{—}}_{RR}, comparator 1006 applies a logical 0 output signal to a control terminal of switch 1008 so that current i_{R} equals the constant current i_{R}_{_{—}}₁ generated by constant current source 1002. The particular value of the constant current i_{R}_{_{—}}₁ generated by constant current source 1002 is a matter of design choice. In the embodiment of graphs 1100, i_{R}_{_{—}}₁=i_{R}=0.7 mA when emulated dimmer output voltage V_{φ}_{_{—}}_{R} is less than reference voltage V_{REF}_{_{—}}_{RR}.

When the emulated dimmer output voltage V_{φ}_{_{—}}_{R} is greater than the reference voltage V_{REF}_{_{—}}_{RR}, comparator 1006 applies a logical 1 output signal to a control terminal of switch 1008 so that current i_{R} equals the constant current i_{R}_{_{—}}₂ generated by constant current source 1004. The particular value of the constant current i_{R}_{_{—}}₂ generated by constant current source 1004 is a matter of design choice. In the embodiment of graphs 1100, i_{R}_{_{—}}₂=i_{R}=0.4 mA when emulated dimmer output voltage V_{φ}_{_{—}}_{R} is greater than reference voltage V_{REF}_{_{—}}_{RR}. The constant currents i_{R}_{_{—}}₁ and i_{R}_{_{—}}₂ are preferably set to values that most accurately cause the dimmer emulator 1000 to approximate the ideal i_{R} versus emulated dimmer output voltage V_{φ}_{_{—}}_{R} 702. The emulated dimmer output voltage V_{φ}_{_{—}}_{R} versus time graph 1102 depicts the emulated dimmer output voltage V_{φ}_{_{—}}_{R} decreasing over time in multiple linear segments 1104 and 1106. Segments 1104 and 1106 of emulated dimmer output voltage V_{φ}_{_{—}}_{R} each have a unique slope. Additionally, in other embodiments, the number of constant current sources in dimmer emulator 1000 can be increased to improve the approximation of emulated dimmer output voltage V_{φ}_{_{—}}_{R}.

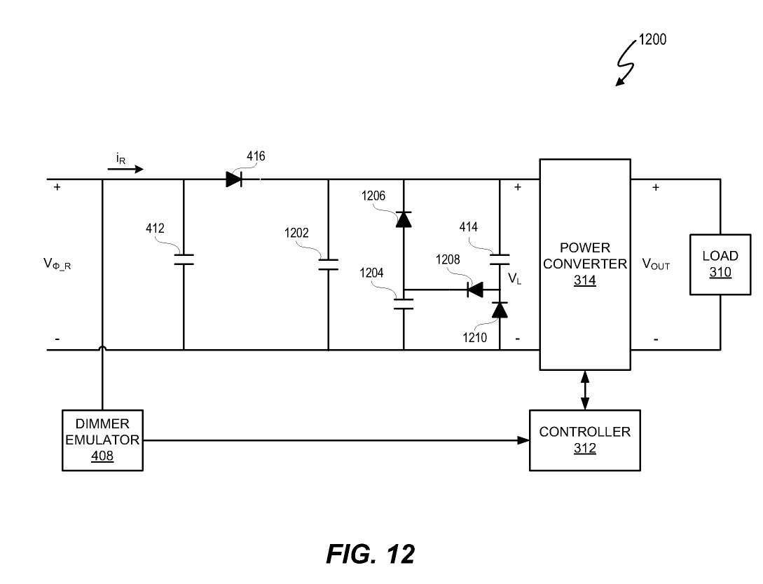

FIG. 12 depicts a lighting system 1200 that includes additional capacitors 1202 and 1204 to, for example, improve power factor correction. In at least one embodiment, the input circuitry to capacitor 412 is identical to the input circuitry of lighting system 400 to capacitor 412. In at least one embodiment, diodes 1206, 1208, and 1210 restrict the direction of current flow so that capacitor 1202 initiates the firing of triac 106 (FIG. 4) and capacitors 1204 and 412 hold the link voltage V_{L} for each cycle of emulated dimmer output voltage V_{φ}_{_{—}}_{R}. Capacitors 1202 is recharged on a low cycle of emulated dimmer output voltage V_{φ}_{_{—}}_{R}, and capacitor 1204 is recharged close to the peak of emulated dimmer output voltage V_{φ}_{_{—}}_{R}.

Thus, a lighting system includes a dimmer output voltage emulator to cause a power converter interface circuit to generate an emulated dimmer output voltage.

Although embodiments have been described in detail, it should be understood that various changes, substitutions, and alterations can be made hereto without departing from the spirit and scope of the invention as defined by the appended claims.

What is claimed is:

1. An apparatus comprising:
a dimmer output voltage emulator configured to cause a power converter interface circuit to generate an emulated dimmer output voltage, wherein the emulated dimmer output voltage emulates part of a cycle of an alternating current dimmer output voltage of a dimmer.

2. The apparatus of claim 1 wherein the emulated dimmer output voltage is generally decreasing over time during the emulated part of the dimmer output voltage cycle.

3. The apparatus of claim 1 wherein the emulated dimmer output voltage comprises multiple linear segments each having a unique slope.

4. The apparatus of claim 1 wherein the emulated dimmer output voltage comprises a concave parabolic waveform.

5. The apparatus of claim 1 wherein the dimmer output voltage emulator is further configured to provide current that interacts with components of the power interface circuit to provide the emulated dimmer output voltage.

6. The apparatus of claim 1 wherein the dimmer output voltage emulator comprises a pull-down circuit to pull-down current of the power converter interface circuit and generally decrease the emulated dimmer output voltage during a first period of time and a glue circuit to maintain the emulated dimmer output voltage below a threshold value during a second period of time.

7. The apparatus of claim 6 wherein the glue circuit provides a steady state current draw from the power converter interface circuit to maintain the emulated dimmer output voltage below the threshold value during the second period of time.

8. The apparatus of claim 6 wherein the first period of time begins when a triac of a triac-based dimmer circuit ceases conducting during a cycle of an AC supply voltage, the second period of time begins when the supply voltage is below the threshold voltage, the first period ends when the second period begins, and the second period ends when the supply voltage begins to increase.

9. A method comprising:
causing a power converter interface circuit to generate an emulated dimmer output voltage, wherein the emulated dimmer output voltage emulates part of a cycle of an alternating current dimmer output voltage of a dimmer.

10. The method of claim 9 wherein causing a power converter interface circuit to generate an emulated dimmer output voltage comprises generally decreasing the emulated dimmer output voltage over time during the emulated part of the dimmer output voltage cycle.

11. The method of claim 9 wherein causing a power converter interface circuit to generate an emulated dimmer output voltage causing a power converter interface circuit to generate the emulated dimmer output voltage to include multiple linear segments each having a unique slope.

12. The method of claim 9 wherein causing a power converter interface circuit to generate an emulated dimmer output voltage causing a power converter interface circuit to generate the emulated dimmer output voltage comprises generating the emulated dimmer output voltage to include a convex parabolic waveform.

13. The method of claim 9 further comprising:
providing current that interacts with components of the power interface circuit to provide the emulated dimmer output voltage.

14. The method of claim 9 further comprising:
pulling-down current of the power converter interface circuit to generally decrease the emulated dimmer output voltage during a first period of time; and
maintaining the emulated dimmer output voltage below a threshold value during a second period of time.

15. The method of claim 14 further comprising:
drawing a steady state current from the power converter interface circuit to maintain the emulated dimmer output voltage below the threshold value during the second period of time.

16. The method of claim 14 wherein the first period of time begins when a triac of a triac-based dimmer circuit ceases conducting during a cycle of an AC supply voltage, the second period of time begins when the supply voltage is below the threshold voltage, the first period ends when the second period begins, and the second period ends when the supply voltage begins to increase.

17. The method of claim 9 further comprising:
generating an emulated dimmer output voltage in a power converter interface circuit, wherein the emulated dimmer output voltage emulates part of a cycle of an alternating current dimmer output voltage of a dimmer

18. An apparatus comprising:
a dimmer;
a power converter interface circuit coupled to the dimmer;
a dimmer output voltage emulator, coupled to the power converter interface circuit, wherein (i) the dimmer output voltage emulator is configured to cause a power converter interface circuit to generate an emulated dimmer output voltage and (ii) the emulated dimmer output voltage emulates part of a cycle of an alternating current dimmer output voltage of a dimmer;
a power converter coupled to the dimmer output voltage emulator; and
a controller coupled to the dimmer output voltage emulator and the power converter, wherein the controller is configured to control the power converter in accordance with the emulated dimmer output voltage.

19. The apparatus of claim 18 wherein:
the dimmer comprises a triac-based dimmer; and
the power converter is a switching power converter.

20. An apparatus comprising:
means for causing a power converter interface circuit to generate an emulated dimmer output voltage, wherein the emulated dimmer output voltage emulates part of a cycle of an alternating current dimmer output voltage of a dimmer.
